(19) United States
(12) Patent Application Publication
(10) Pub. No.: US 2013/0215058 A1
(43) Pub. Date: Aug. 22, 2013

(54) In-Room Hospitality Devices and Systems

(71) Applicants: Robert Vern Brazell, Salt Lake City, UT (US); Alexander David Wissner-Gross, Cambridge, MA (US); Timothy Michael Sullivan, Cambridge, MA (US)

(72) Inventors: Robert Vern Brazell, Salt Lake City, UT (US); Alexander David Wissner-Gross, Cambridge, MA (US); Timothy Michael Sullivan, Cambridge, MA (US)

(21) Appl. No.: 13/770,841

(22) Filed: Feb. 19, 2013

Related U.S. Application Data
(60) Provisional application No. 61/599,831, filed on Feb. 16, 2012.

(51) Int. Cl. G06F 3/0488

(52) U.S. Cl. CPC G06F 3/0488
USPC 345/173

(57) ABSTRACT

The present invention is generally directed to hospitality systems and in-room hospitality computer devices that are configured to communicate with or control other devices or systems within a hotel. In some aspects, a unified in-room hospitality device comprises a mobile computing device, such as a tablet computer, that is secured in place by an encasement in a hotel room. The encasement can be, for example, secured to a table surface of a night stand.

### CROSS-REFERENCE TO RELATED APPLICATIONS

This application claims priority to U.S. Provisional Patent Application No.: 61/599,831, filed Feb. 16, 2012.

### BACKGROUND

Hotels can provide guests with various amenities and services that can make their stay more pleasant and enjoyable. These services have historically included television service, cable service, internet service, concierge service, room service, wake-up services, and other such hospitality services. These services may be facilitated by an in-room telephone that allows guests to make calls requesting hotel services. Some such telephones may have multiple buttons that each directly link the phone with the appropriate area of the hotel for handling particular service requests. These phones can also allow outgoing calls by guests. Such telephones could be placed on a desk or night stand along with a television remote control, telephone directory, hotel service directory, and information about local attractions or offers. While these services and devices are useful, improvements would be desirable.

### BRIEF SUMMARY

The present invention is generally directed to hospitality systems and in- room hospitality computer devices that are configured to communicate with or control other devices or systems within a hotel. In some aspects, a unified in-room hospitality device comprises a mobile computing device, such as a tablet computer, that is secured in place by an encasement in a hotel room. The encasement can be, for example, secured to a table surface of a night stand.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an in-room hospitality computer device in accordance with one or more embodiments of the invention;

FIG. 2 illustrates a network environment in which the in-room hospitality computer device can be used;

FIG. 3 illustrates an example user interface that can be displayed by an in-room hospitality computer device;

FIG. 4 illustrates an in-room hospitality computer device mounted to a table;

FIG. 5 illustrates an in-room hospitality computer device mounted to the wall; and

FIG. 6 illustrates an in-room hospitality computer device tethered to a table.

### DETAILED DESCRIPTION

The present invention is generally directed to hospitality systems and in- room hospitality computer devices that are configured to communicate with or control other devices or systems within a hotel. In some aspects, a unified in-room hospitality device comprises a mobile computing device, such as a tablet computer, that is secured in place by an encasement in a hotel room. The encasement can be, for example, secured to a table surface of a night stand.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

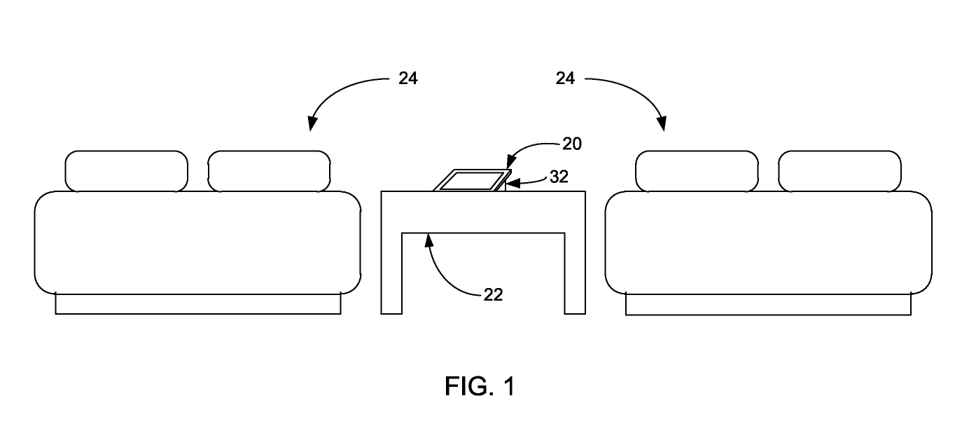

Reference will now be made to FIG. 1, which illustrates a representative in-room hospitality computer device 20. As shown, the computer device 20 can be located in a hotel room, such as on a bedside table 22 between two beds 24. In other instances the computer device 20 can be located in other locations in a hotel room, such as on a wall, on a desk, or on another piece of furniture. Similarly, the computer device 20 can be located in other parts of a hotel or in another hospitality facility.

The computer device 20 can provide a number of varied services to a guest. For example, the computer device 20 can be configured to provide concierge services, internet communication services, telephone services, movie services, room services, automation control services, information services, gaming services and/or other such hospitality services. Each of these services can be provided via one or more computer programs or software applications running on the computer device 20. Given the general ability of computers to be updated and modified, the computer device 20 can provide a dynamic, modern, and useful feature to a hotel room.

FIG. 1 illustrates an example where the computer device 20 is a tablet. However, other types of computer devices can also be used to provide an in-room hospitality computer device 20.

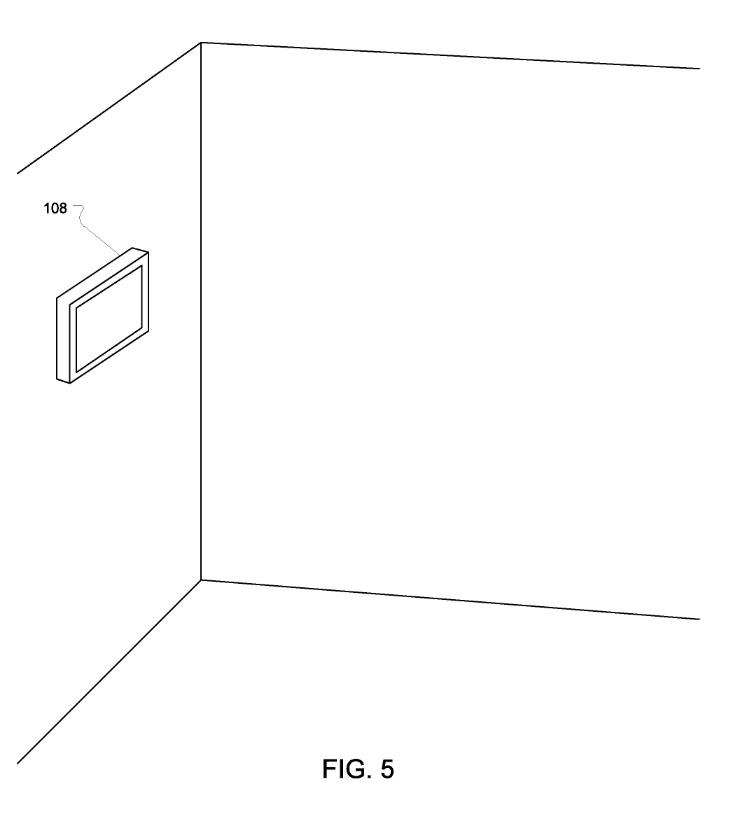

As shown in FIG. 1, in various embodiments, the computer device 20 can be placed on or secured to a table. Similarly, as shown in FIG. 5, a computer device 20 can be connected to another surface, such as a wall. The computer device 20 of FIG. 1 is secured to a mount 32 that can support the computer device 20 in a flat, an angled, or upright position. For example, the mount 32 can be fixed or adjustable.

The mount 32 can also serve as a security mechanism that locks the computer device 20 in place to prevent damage to or theft of the computer device 20. Additionally, while the computer device 20 can be useful in many locations, in some instances as shown in FIG. 1, it is placed at the bedside. In this location, the computer device 20 can be suitably located to control the television, the room temperature, room lighting, access hotel services (e.g., room service, etc.), and access communication services. In other instances, the computer device 20 can be fixed to a desk, television stand, or a wall.

The mount 32 can secure the computer device 20 to the surface of a piece of furniture, a wall, or another surface using one or more fasteners. For example, as shown, the mount 32 can be screwed, nailed, riveted, glued, or otherwise fastened to the surface of the bedside table 22. Moreover, the mount 32 can fix the computer device 20 in place in a manner that does not permit movement of the computer device 20 or its orientation. In some embodiments, the mount 32 can allow the computer device 20 to be angled and/or rotated which can facilitate use of the computer device 20 from any position (e.g. from either bed 24).

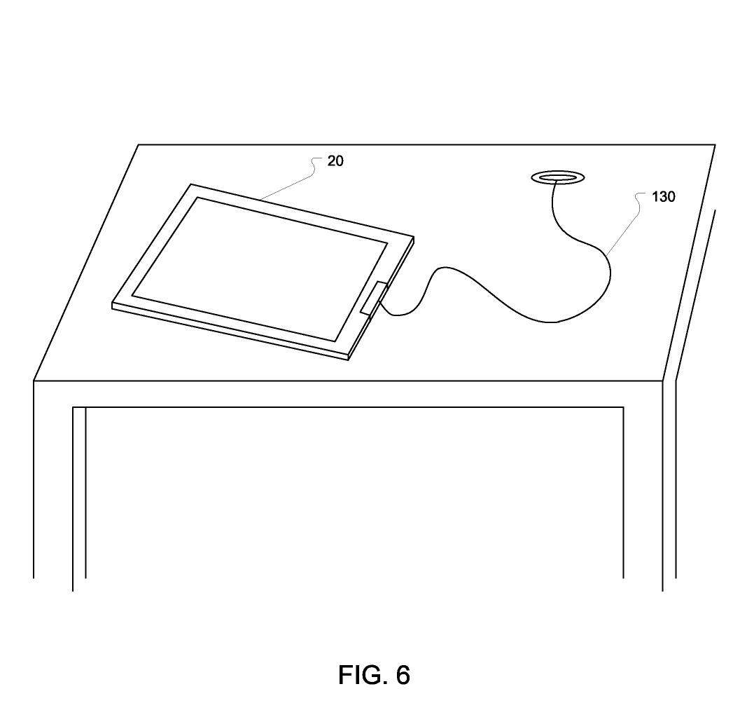

In some embodiments, the orientation of the user interface can be rotated as desired so that the user interface faces the appropriate direction. In some embodiments, the mount 32 can be modified to include or can be replaced with a tether device, which is shown in FIG. 6 and described below. In some embodiments, the mount 32 can include docking capabilities to provide the computer device 20 with power, network, or other connections while connected to the mount 32.

Alternatively, the computer device 20 can be available without the restraint of a mount 32 or tether. For instance, the hotel can provide the computer device 20 as a free service or paid service upon the receipt of a valid credit card number. In these instances, if the computer device 20 is damaged, lost, or stolen, the hotel can charge the guest's credit card. Computer devices 20 can thus be available for rent or for free use by the hotel. In some instances, the hotel can provide the guest with a key with which the guest can access and/or unlock the computer device 20 from its storage or secured location in the hotel room. The key can remove the computer device 20 from the mount 32, a safe, a drawer, or other location.

Although the figures illustrate the computer device 20 as a tablet, the computer device 20 can be implemented in other forms such as a monitor connected to a computer device, an app of a smart television, etc. In a particular embodiment, the computer device 20 can be implemented as a touch screen device that is connected to a central server. Such touch screen devices can be mounted within a room or many rooms and be controlled by the central server.

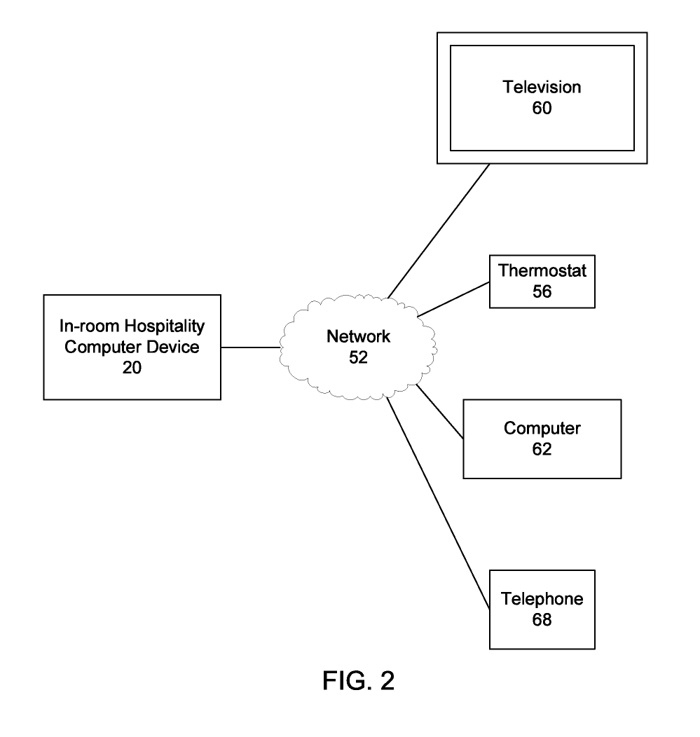

As shown in FIG. 2, the computer device 20 can be connected with a variety of other computers or devices including a thermostat 54 (or other device for controlling an HVAC system), a television 60, another computer 62 (e.g. a hotel server, a computer device 20 in another room, etc), and a telephone system 68. Each of these devices and systems will be described below.

By communicating with thermostat 56, computer device 20 can control the operations of an HVAC unit to adjust the temperature and ventilation of the guest's room. For example, with computer device 20 located near bed 24, while lying in bed, the guest can interact with controls displayed on computer device 20 to turn the heat or air conditioning on or off, adjust the temperature, or adjust other settings provided by thermostat 56. Similar controls can be provided to allow the guest to control the lights within the room.

In embodiments where computer device 20 is connected to television 60, computer device 20 can act similar to a remote control. For example, the guest can turn the television on or off, change the channel, order movies, or interact with any other feature provided on television 60.

Computer 62 can represent many different types of computer systems used by a hotel to provide guest services. For example, computer 62 can be a front desk system, a concierge system, restaurant system, a spa system, a pool system, etc. In such cases, the guest can use computer device 20 to order room service, schedule spa visits, make a golf tee-time, schedule an event, pay a bill, request dry cleaning, etc. Computer 62 can also represent a database of information or entertainment accessible to the guest. For example, computer 62 can represent the circuitry for providing computer device 20 with access to the internet.

Telephone 68 can represent one or more in-room telephones or a telephone system provided by the hotel. Computer device 20 can be used to place or receive phone calls or to check voicemail. In some embodiments, computer device 20 can also be used as a video display for video conferencing. Accordingly, computer device 20 can act as an enhancement to typical phone systems provided in hotels.

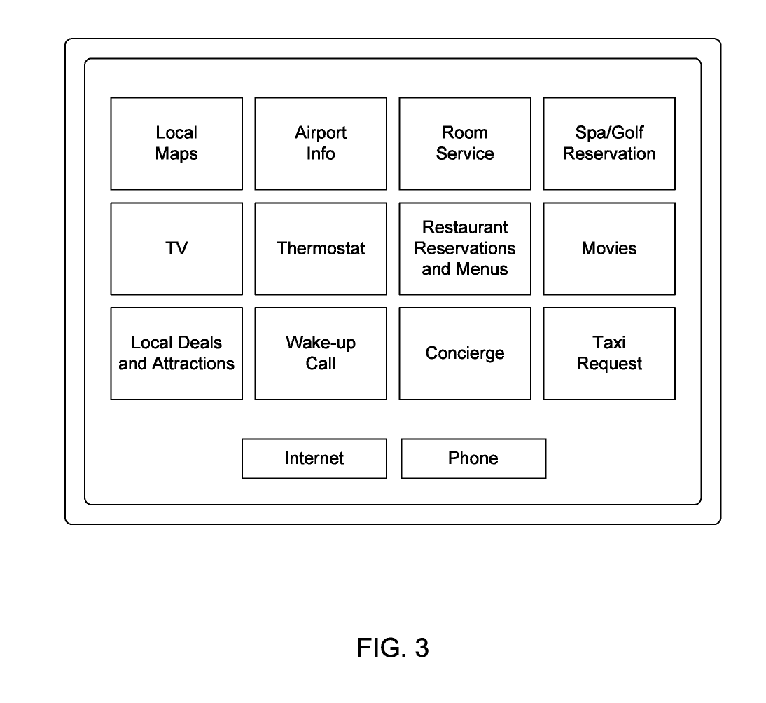

FIG. 3 illustrates an example user interface that can be displayed on computer device 20. By selecting a user interface element representing a service, computer device 20 performs the necessary functionality to communicate appropriate commands or requests to implement the service.

For example, when the Room Service element is selected, computer device 20 can display a menu and provide controls for placing an order. Similarly, when the Spa/Golf Reservation is selected, available spa services or tee-times can be displayed with controls for placing a reservation. When the Thermostat element is selected, computer device 20 can display controls for adjusting one or more settings of the HVAC system. Likewise, when the other elements are selected, computer device 20 can display appropriate controls to allow the guest to perform a desired function, receive desired information, place a desired order, etc.

In some embodiments, the Phone element can provide the guest with the ability to use the in-room telephone system via computer device 20. In some embodiments, the guest can also or alternatively be provided with the ability to use internet based phone services (e.g. Skype) using computer device 20.

As can be seen, computer device 20 provides a centralized device through which the guest can have access to and control many different systems or services provided in the hotel. Computer device 20 can therefore replace many of the current devices used to provide such access and control. Further, because computer device 20 can easily be updated, the costs associated with maintaining many different systems and devices can be reduced.

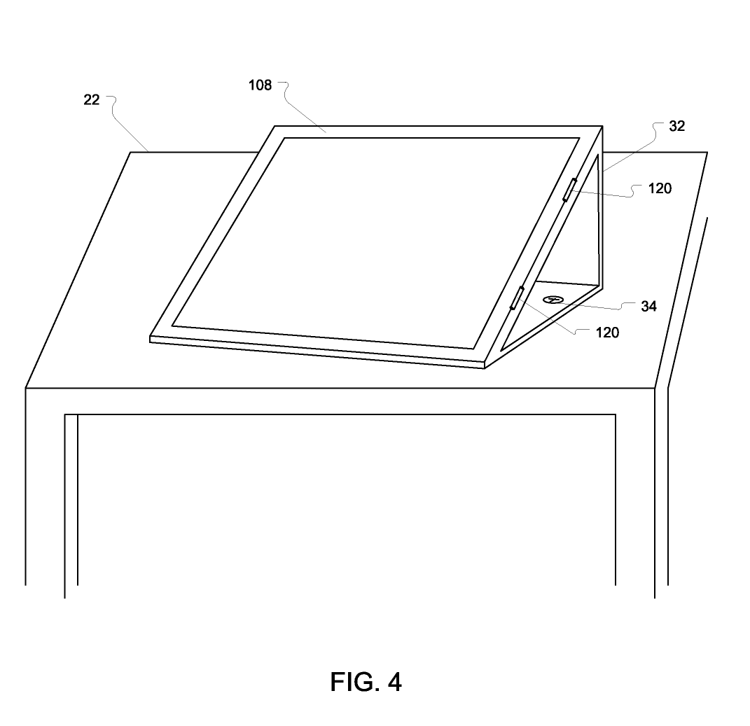

FIG. 4 illustrates an example of mount 32 that can be used to attach computer device 20 to a surface such as a table top. In FIG. 4, mount 32 is shown in a fixed inclined position. However, as stated above, a mount 32 can be configured to allow the adjustment of the incline angle or rotational orientation of computer device 20.

The mount 32 can serve as a security mechanism that locks the computer device 20 in place to prevent damage to or theft of the computer device 20. For example, as shown, the mount 32 can be screwed, nailed, riveted, glued, or otherwise fastened to the surface of the bedside table 22 using one or more fasteners 34.

In some configurations, the computer device 20 can be secured within an encasement 108 that is secured to the mount 32. The encasement 108 can function to both protect the computer device 20 and to secure the computer device 20 to the mount 32. The encasement 108 can be configured to provide access to the touch screen, an on-off button, a microphone, a camera, or one or more other devices on computer device 20. In some embodiments, the encasement 108 can be configured to open (e.g. via hinges 120) and be secured with a lock (not shown). In such cases, a guest can be provided with a key that allows the guest to access and/or unlock the computer device 20.

FIG. 5 illustrates an alternative embodiment where an encasement 108 is mounted to the wall. Computer device 20 can be secured within encasement 108 in a similar manner as described above.

Turning now to FIG. 6, in some embodiments, the computer device 20 can be secured to a table or other object via a tether 130. The tether 130 can have various lengths that enable the computer device 20 to be moved within a hotel room. The tether 130 can be made of various flexible or semi-flexible materials or structures that do not break when moved about or pulled on. The tether 130 can thus provide a guest with some ability to move the computer device 20 about the hotel room.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A system for providing centralized access to hotel services via a computer device, the system comprising:
a computer device having a touch screen display, the computer device having computer executable instructions which when executed display a user interface on the touch screen display, the user interface including a plurality of user interface elements which when selected each display one or more controls for accessing a different service provided by a hotel to thereby allow a guest to access the different services from the computer device within a hotel room.

2. The system of claim 1, wherein the computer device is a tablet.

3. The system of claim 2, further comprising:
a mount that is configured to secure the tablet to a surface in the hotel room.

3. The system of claim 3, wherein the surface is a surface of a table.

4. The system of claim 2, wherein the surface is a wall.

5. The system of claim 2, further comprising:
a tether that is configured to secure the tablet to a structure within the hotel room.

6. The system of claim 5, wherein the structure is a wall.

7. The system of claim 5, wherein the structure is a piece of furniture.

8. The system of claim 2, wherein the mount includes an encasement that contains the computer device.

9. The system of claim 8, wherein the encasement is locked with a key.

10. The system of claim 8, wherein the encasement is configured to be opened to allow the computer device to be removed by the guest.

11. The system of claim 1, wherein the different services include at least two or more of the following:
a concierge service;
a thermostat;
a television;
room service;
a telephone;
an information service; or
a reservation service.

12. The system of claim 1, wherein the different services include a thermostat and a television.

13. The system of claim 1, wherein the computer device is connected via a network to one or more other computer devices in another guest room to enable the computer device to control services provided within the other guest room.

14. The system of claim 1, further comprising:
another computer device having a touch screen display, the other computer device having computer executable instructions which when executed display a user interface on the touch screen display, the user interface including a plurality of user interface elements which when selected each display one or more controls for accessing a different service provided by the hotel to thereby allow the guest to access the different services from the other computer device within the hotel room.

15. A system for providing centralized access to hotel services via a computer device, the system comprising:
a computer device having a touch screen display, the computer device having computer executable instructions which when executed display a user interface on the touch screen display, the user interface including a plurality of user interface elements which when selected each display one or more controls for accessing a different service provided by a hotel to thereby allow a guest to access the different services from the computer device within a hotel room;
a mount attached to a surface in the hotel room, the mount being configured to secure the computer device to the surface.

16. The system of claim 15, wherein the mount is adjustable to allow the angle and orientation of the computer device to be adjusted when secured to the mount.

17. The system of claim 15, wherein the different services include:
a thermostat service for controlling the settings of an in-room thermostat; and
a television service for controlling an in-room television.

18. The system of claim 17, wherein the different services further include:
a reservation service for placing reservations at one or more of a restaurant, a spa, or a golf course.

19. The system of claim 17, wherein the different services further include:
a room service for placing room service orders.

20. The system of claim 17, wherein the different services further include:
an internet service that provides internet access on the computer device; and
a phone service that enables phone calls to be placed or received from the computer device.
